(19) United States
(12) Patent Application Publication
(10) Pub. No.: US 2024/0225339 A9
(43) Pub. Date: Jul. 11, 2024

(54) COOKING APPLIANCE AND HEATING ARRANGEMENT THEREFOR

(71) Applicant: KENWOOD LIMITED, Havant, Hampshire (GB)

(72) Inventors: James ROBINSON, Havant (GB); Kevin SNOAD, Havant (GB); Bradley CUNNINGHAM, Havant (GB)

(21) Appl. No.: 17/769,367

(22) PCT Filed: Sep. 30, 2020
(86) PCT No.: PCT/GB2020/052372

§ 371 Date: Apr. 15, 2022

(30) Foreign Application Priority Data
Oct. 17, 2019 (GB) 1915042.4
Oct. 25, 2019 (LU) LU101455

(51) Int. Cl. A47J 27/00; A47J 43/07

(52) U.S. Cl. CPC A47J 27/004; A47J 43/0727; A47J 43/0755; A47J 2202/00

(57) ABSTRACT

A heating arrangement for a cooking appliance comprises a heating element, a container, a container receiving member, and a cooling element configured to directly cool both the heating element and the container when the container is received in the container receiving member.

The present invention relates to a heating arrangement for a cooking appliance, and to a cooking appliance, preferably a stand mixer, incorporating the same.

Current state of the art kitchen appliances with heating elements tend to feature a single temperature sensor (e.g., an NTC—negative temperature coefficient—thermistor) to sense bowl-temperature, with additional mechanical thermal cutouts mounted on the element. For machines with separate bowl and heating elements, both require a thermal mass (i.e., an additional mass for absorbing and storing heat, buffering temporary changes in heating element output and promoting the even spread of heat over the bottom of the bowl) to ensure adequate thermal transfer from the element to the in-bowl ingredients.

The present invention seeks to overcome problems associated with such kitchen appliances.

Aspects and embodiments of the present invention are set out in the appended claims. These and other aspects and embodiments of the invention are also described herein.

According to an aspect of the invention, there is provided a heating arrangement for a cooking appliance comprising: a heating element; a container; a container receiving member; and a cooling element configured to directly cool both the heating element and the container when the container is received in the container receiving member.

Optionally, a fluid flow-path is defined when the container is received in the container receiving member, and preferably the cooling element is configured to drive fluid along the fluid flow path.

Optionally, the fluid flow-path is defined by at least the heating element and the container, and preferably the fluid flow-path is defined by an outer surface of the container, and more preferably the fluid flow-path is guided around the outer surface of the container by the container receiving member.

Optionally, the container receiving member and the heating element define a gap and the fluid flow-path is further defined by the gap, and preferably the gap is substantially annular.

Optionally, the fluid driven along the fluid flow-path cools the heating element then the container.

Optionally, the cooling element is a direct fluidic cooling element and preferably a fan. Preferably, the fan has only one speed, although it may have two or more speeds

Optionally, the container receiving member is configured to releasably receive the container.

Optionally, the heating element is integral to the container.

Optionally, the cooling element is integral to the container.

Optionally, the cooling element is configured to selectively operate in a cooling mode or a transfer mode, and preferably in the cooling mode both the heating element and the container are cooled, and preferably in the transfer mode heat is transferred from the heating element to the container in a sustained manner, and preferably in the transfer mode the cooling element is configured to promote thermal transfer between the heating element and the container.

Optionally, in the transfer mode the cooling element is configured such that the container is not cooled by the cooling element.

Optionally, in the cooling mode the cooling element operates at a first speed and in the transfer mode the cooling element operates at a second speed, and preferably the first speed is faster than the second speed.

Optionally, the heating arrangement further comprises a thermal mass positioned between the heating element and the container, and preferably the thermal mass is integral with the container. Preferably, the thermal mall has a thickness of at least 5 mm.

Optionally, the thermal mass comprises a material having a thermal conductivity of at least approximately 200 W/mK, and is preferably either Aluminium or Copper.

Optionally, the heating arrangement further comprises: a controller configured to: determine a heating element temperature; determine a container temperature; and energise the heating element and/or the cooling element based on the heating element temperature and the container temperature, and preferably based on the difference between the heating element temperature and the container temperature.

According to an aspect of the invention, there is provided a heating arrangement for a cooking appliance, comprising: a container; a heating element; and a controller configured to: determine a heating element temperature; determine a container temperature; and energise the heating element based on the heating element temperature and the container temperature, and preferably based on the difference between the heating element temperature and the container temperature.

Optionally, the heating arrangement further comprises a heating element temperature sensor and a container temperature sensor both operatively coupled to the controller.

Optionally, the heating element temperature is sensed using the heating element temperature sensor. Optionally, the container temperature is sensed using the container temperature sensor.

Optionally, the controller is further configured to receive a desired temperature and preferably the energising of the heating element and/or a/the cooling element is further based on the desired temperature.

Optionally, the desired temperature is a desired temperature of the heating element. Alternatively, the desired temperature is a desired temperature of the container.

Optionally, the controller is further configured to energise the heating element to heat the container to the desired temperature.

Optionally, energising the heating element and/or a/the cooling element is based on the difference between the container temperature and heating element temperature exceeding a threshold.

Optionally, the threshold is no more than approximately 5 degrees C., and preferably approximately between 5 and 1 degrees C., and more preferably wherein the predetermined difference is no more than 1 degree C.

Optionally, the amount the heating element and/or a/the cooling element are energised is dependent on the difference between the container temperature and heating element temperature and dependent on the difference between the container temperature and a/the desired temperature.

The controller may be configured to: (a) determine whether the temperature of the heating element exceeds a predetermined maximum temperature, wherein the predetermined maximum temperature is preferably less than about 150 degrees C., more preferably between 100 and 150 degrees C., and if so to energise the cooling element and optionally deactive the heating element, and subsequently to (b) determine whether the temperature of the heating element has fallen below the predetermined maximum temperature by a predetermined amount, preferably up to about 5 degrees and more preferably 4 to 5 degrees, and if so to deactivate the cooling element and optionally energise the heating element. Preferably the controller is configured to repeat the steps (a) and (b) until the container reaches a required temperature.

Preferably, in response to an indication that the appliance is in a predetermined state, preferably an inactive state, the controller is arranged to determine whether the temperature of the container and/or the heating element is above a predetermined threshold, preferably a safe threshold, optionally below about 40 degrees C., and if so, to activate the cooling element until the temperature falls below the threshold by a predetermined amount, preferably about 4 to 5 degrees or more, optionally to about 35 degrees C. or less.

Optionally, the cooling element is configured to be controlled manually by a user.

Optionally, the heating element and/or a/the cooling element are energised on or off dependent on the difference between the container temperature and the heating element temperature.

Optionally, the heating arrangement further comprises a container temperature sensor and a resilient element, wherein the resilient element urges the container temperature sensor against the container and preferably the heating element is configured to be urged against the container.

According to an aspect of the invention, there is provided a heating arrangement for a cooking appliance, comprising: a heating element; a cooling element; and a controller configured to: (a) determine whether the temperature of the heating element exceeds a predetermined maximum temperature, wherein the predetermined maximum temperature is preferably less than about 150 degrees C., more preferably between 100 and 150 degrees C., and if so to energise the cooling element and optionally deactive the heating element, and subsequently to (b) determine whether the temperature of the heating element has fallen below the predetermined maximum temperature by a predetermined amount, preferably up to about 5 degrees and more preferably 4 to 5 degrees, and if so to deactivate the cooling element and optionally energise the heating element.

According to an aspect of the invention, there is provided a heating arrangement for a cooking appliance, comprising: a heating element; a container; a resilient element; and a container temperature sensor, wherein the resilient element is configured to urge both the container temperature sensor and the heating element against the container.

Optionally, a/the controller is configured to permit activation of the heating element responsive to the resilient element being urged against the container.

Optionally, the heating arrangement further comprises an interlock, the interlock being configured to permit activation of the heating element and/or the cooling element responsive to the resilient element being urged against the container.

Optionally, the heating element of any of the heat arrangement aspects as herein described has a maximum achievable temperature of less than approximately 100 degrees C., and more preferably equal to or less than approximately 95, 90, 80, 75, 70 65, 60, 55, 50, 45, 40, 35, or 30 degrees C., and yet even more preferably equal to or less than approximately 70 degrees C.

Optionally, the heating element has a power rating of less than or equal to 750, 700, 600, 500, 400, 300 or 250 watts.

Optionally, the heating arrangement further comprises a heating element temperature sensor. Preferably, the heating element temperature sensor is mounted directly onto the underside of the heating element.

According to an aspect of the invention, there is provided a method for a heating arrangement comprising the steps: measuring a heating element temperature; measuring a container temperature; and energising the heating element and/or the cooling element based on the heating element temperature and the container temperature, and preferably based on the difference between the heating element temperature and the container temperature.

Optionally, the method further comprises the step of receiving a desired temperature and preferably the energising of the heating element and/or a/the cooling element is further based on the desired temperature.

Optionally, the method further comprises the step of energising the heating element to the desired temperature.

Optionally, energising the heating element and/or a/the cooling element is based on the difference between the container temperature and heating element temperature exceeding a threshold.

Optionally, the threshold is no more than approximately 5 degrees C., and preferably approximately between 5 and 1 degrees C., and more preferably wherein the predetermined difference is no more than 1 degree C.

Optionally, the amount the heating element and/or a/the cooling element are energised is dependent on the difference between the container temperature and heating element temperature and dependent on the difference between the container temperature and a/the desired temperature.

Optionally, the heating element and/or a/the cooling element are energised on or off dependent on the difference between the container temperature and the heating element temperature.

According to an aspect of the invention, there is provided a cooking appliance, preferably a stand-mixer, comprising: a container receiving member configured to releasably retain a container; a heating element, preferably configured to heat to a maximum temperature of less than 100 degrees C., and more preferably to approximately 90, 80, 75, 70 65, 60, 55, 50, 45, 40, 35, or 30 degrees or less, and optionally a resilient urging means configured to urge the heating element into contact with the container when located in the container receiving member.

Optionally, the container receiving member and the heating element co-operatively define a gap therebetween for the flow of air therethrough when a container is located in the container receiving member.

Preferably, the heating element of any of the aspects as herein described is located within a housing of the cooking appliance. Preferably, the heating element is located within a housing of the heating arrangement and the heating arrangement is located within the cooking appliance.

Preferably, the cooling element is located beneath the heating element.

According to an aspect of the invention, there is provided a heating arrangement for a cooking appliance comprising: a heating element; a container; a cooling element configured to cool, preferably directly cool, both the heating element and the container.

Optionally, the cooling element is a direct fluidic cooling element.

Optionally, the direct fluidic cooling element is a fan.

Optionally, the fluidic cooling element is configured to drive fluid along a fluid flow-path impinging on both the heating element and the cooling element, and preferably to impinge first on the heating element and then on the container.

Optionally, the fluidic cooling element is configured to selectively operate at either a first speed wherein the both the heating element and the container are cooled, or at a second speed slower than the first speed in which heated fluid is driven from the heating element to heat the container in a sustained manner.

Optionally, the heating arrangement further comprises a thermal mass positioned between the heating element and the container.

Optionally, the thermal mass is integral to the container.

Optionally, the thermal mass comprises a material having a thermal conductivity of at least approximately 200 W/mK, and is preferably either Aluminium or Copper.

Optionally, the thermal mass has a thickness of at least 5 mm.

Optionally, the heating arrangement further comprises a first temperature sensor configured to sense a temperature of the heating element, a second temperature sensor configured to sense a temperature of the container, and a controller configured to control heating element and/or the cooling element responsive to feedback from the first temperature and the second temperature sensor.

Optionally, the controller is configured to measure a difference in temperature between the temperature measured by the first temperature sensor and the temperature measured by the second temperature sensor, and to control the heating element and/or cooling element responsive to the difference.

Optionally, the controller is configured to control the heating element and/or the cooling element responsive to the measured difference exceeding a predetermined difference, preferably wherein the predetermined difference is no more than approximately 5 degrees C., and more preferably approximately between 5 and 1 degrees C., and more preferably still where the predetermined difference is no more than 1 degree C.

Optionally, the second temperature sensor is urged against the container by a resilient element.

Optionally, the heating element is urged by a resilient element against the container.

Optionally, the same resilient element urges both the first temperature sensor and the heating element against the container.

Optionally, the heating arrangement further comprises an interlock, the interlock being configured to permit activation of the heating element and/or the cooling element responsive to the resilient element being urged against the container.

According to an aspect of the invention, there is provided a cooking appliance comprising the heating arrangement of any preceding claim, and further comprising a container-seat configured to receive the container in releasable attachment.

Optionally, the cooling element is located within a housing of the cooking appliance, preferably beneath the heating element.

Optionally, the fluid flow-path is guided around a surface of the container by the container-seat.

Optionally, the cooking appliance further comprises a tool configured to agitate contents of the container.

Optionally, the heating element has a maximum achievable temperature of less than approximately 100 degrees C., and more preferably equal to or less than approximately 70 degrees C.

According to an aspect of the invention, there is provided a heating arrangement comprising: a heating element, a container, a thermal mass configured to convey heat from the heating element to the container, a first temperature sensor configured to sense a temperature of the heating element, a second temperature sensor configured to measure a temperature of the container, a controller configured to control the heating element based on feedback from the first and second temperature sensors, and preferably based on a measured difference between the temperatures sensed by the first and second sensors.

According to an aspect of the invention, there is provided a method for carrying out a cooking process, comprising steps of: a) receiving a desired temperature at a cooking appliance, b) energising a heating element, and transmitting heat through a thermal mass to a container, to heat a container to the desired temperature, c) sensing, via a first heat sensor associated with the heating element, a first temperature, d) sensing, via a second heat sensor associated with the container, a second temperature, and e) controlling the heating element and/or a cooling element to heat and/or cool the container based on the first and second temperatures, and preferably based on a difference between the first and second temperatures.

According to an aspect of the invention, there is provided a cooking appliance, preferably a stand-mixer, comprising: a container seat configured to releasably retain a container, a heating element, preferably configured to heat to a maximum temperature of less than 100 degrees C., and more preferably to approximately 70 degrees or less, and preferably with a resilient urging means configured to urge the heating element into contact with the container when located in the container seat.

Optionally, the container seat and the heating element co-operatively define a gap therebetween for the flow of air therethrough when a container is located in the container seat.

According to an aspect of the invention, there is provided a cooking appliance comprising a heating element configured to heat to a maximum temperature of less than 100 degrees C., preferably to approximately 70 degrees or less, more preferably to 70 degrees.

According to an aspect of the invention, there is provided a heating arrangement for a cooking appliance including a container, the heating arrangement optionally according to any aspect as herein described, the heating arrangement comprising: a heating element for heating the container, wherein the heating element has a power rating of less than or equal to 750W, and preferably less than or equal to 500W, and more preferably less than or equal to 300W or 250W, and/or wherein the heating element is configured to heat to a maximum temperature of 100 degrees C. or less, more preferably 70 degrees C. or less; preferably further comprising a controller configured to energise the heating element, and preferably energise the heating element based on a temperature of the container.

Optionally, the heating arrangement further comprises a container receiving member configured to releasably retain the container; and a resilient urging means configured to urge the heating element into contact with the container when located in the container receiving member.

According to an aspect of the invention, there is provided a heating arrangement for a cooking appliance including a container comprising: a heating element, wherein the heating element has a power rating of less than or equal to 750W, and preferably less than or equal to 500W, and preferably less than or equal to 300W, and preferably less than 250W; a controller configured to energise the heating element, and preferably energise the heating element based on a temperature of the container; preferably further comprising a cooling element configured to cool the heating element and the container, and more preferably configured to directly cool both the heating element and the container when the container is received in a container receiving member; preferably further comprising a container temperature sensor and a heating element temperature sensor operatively coupled to the controller such that the controller is configured to: determine a heating element temperature; determine a container temperature; and energise the heating element based on the heating element temperature and the container temperature, and preferably based on the difference between the heating element temperature and the container temperature.

According to an aspect of the invention, there is provided a cooking appliance, preferably a stand mixer, comprising: the heating arrangement according to any aspect as herein described; and preferably a tool configured to agitate contents of the container. Preferably, the cooking appliance comprises a heating arrangement comprising a resilient member configured to urge the heating element and the container temperature sensor against the container. Preferably, the heating arrangement comprises a cooling element configured to operate in a cooling and/or transfer mode. Preferably, the heating arrangement comprises a cooling element configured to cool or impinge on the container when the container is received within the container receiving member. Preferably, the heating arrangement comprises a cooling element configured to cool or impinge on the heating element then the container. Preferably, the heating arrangement comprises a controller configured to sense the temperature difference between the container and the heating element and adjust the amount a heating element and/or a cooling element is energised.

In a further aspect, the present invention provides any, some or all of the features:
the cooking appliance is configured to temper chocolate and preferably the cooking appliance receives the type of chocolate being tempered and adjusts a desired temperature of the contents of the container.
the cooking appliance is configured to proof dough, where the cooking appliance comprises a dough hook as the tool to knead the dough during the proofing process.
the cooking appliance is configured to maintain the contents of the bowl at a temperature lower than room temperature.
the cooking appliance is configured to receive recipes from a recipe data base and, using the user interface, selects recipes to cook. The recipes comprise the times and temperatures the heating element and/or cooling element are energised to.
the cooling element does not directly impinge on the container and instead the cooling element only impinges on the heating element when the container is received in the container receiving member. The cooling element thereby indirectly cools the container as a result of the heating element being in direct contact with the container.
the heating arrangement comprises a micro-switch such that when a controller can determine when a container is received within the container receiving member. The micro-switch may be located in the container receiving member. By knowing when the container is/isn't in the container receiving member, any one or more of the following are possible:
   safely enable/disable the heating element only when container is received;
   safely enable/disable the cooling element only when container is received;
   enable the tool only when container is received; and/or
   display to a user that the container is received correctly.
the container temperature sensor may be used in place of the micro-switch as described above for determining if the container is received in the container receiving member. If the temperature measured by the container temperature sensor is significantly different from the heating element temperature sensor then it is likely the container temperature sensor is open to the air and not pressed against a container. A significant difference can be less than or equal to 5, 3, 1, or 0.5 degrees centigrade.

The invention described here may be implemented in heated and/or cooled machines. It may be used in a machine that is built-in to a work-top or work surface, or in a stand-alone device. The invention can also be provided as a stand-alone device, whether motor-driven or manually powered.

The invention extends to methods and/or apparatus substantially as herein described and/or as illustrated in the accompanying drawings.

The invention extends to any novel aspects or features described and/or illustrated herein. In addition, apparatus aspects may be applied to method aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

As used herein, means plus function features may be expressed alternatively in terms of their corresponding structure, such as a suitably programmed processor and associated memory, for example.

The invention described here may be used in any appliance, such as a kitchen appliance, and/or as a stand-alone device. This includes any domestic food-processing and/or preparation appliance, including both top-driven appliances (e.g., stand-mixers) and bottom-driven appliances (e.g., food processors). It may be implemented in heated and/or cooled appliances. The invention may also be implemented in both hand-held (e.g., hand blenders) and table-top (e.g., blenders) appliances. It may be used in an appliance that is built-in to a work-top or work surface, or in a stand-alone device. The invention can also be provided as a stand-alone device, whether motor-driven or manually powered.

Whilst the invention has been described in the field of domestic food processing and preparation appliances, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances. Any reference to “food”, “beverage” (or similar language) herein may be replaced by such working mediums.

As used herein, the term “processing” preferably connotes any action relating to or contributing towards transforming products into foodstuff, or transforming foodstuff into a different form of foodstuff, including—as examples—applying mechanical work (e.g. for cutting, beating, blending, whisking, dicing, spiralising, grinding, extruding, shaping, kneading etc.) and applying heat or cold. “Food” and “foodstuff” as used herein can include beverages and frozen material and material used in creating them (e.g., coffee beans).

In order that the invention may be more readily understood, reference will now be made to the accompanying drawings, in which:

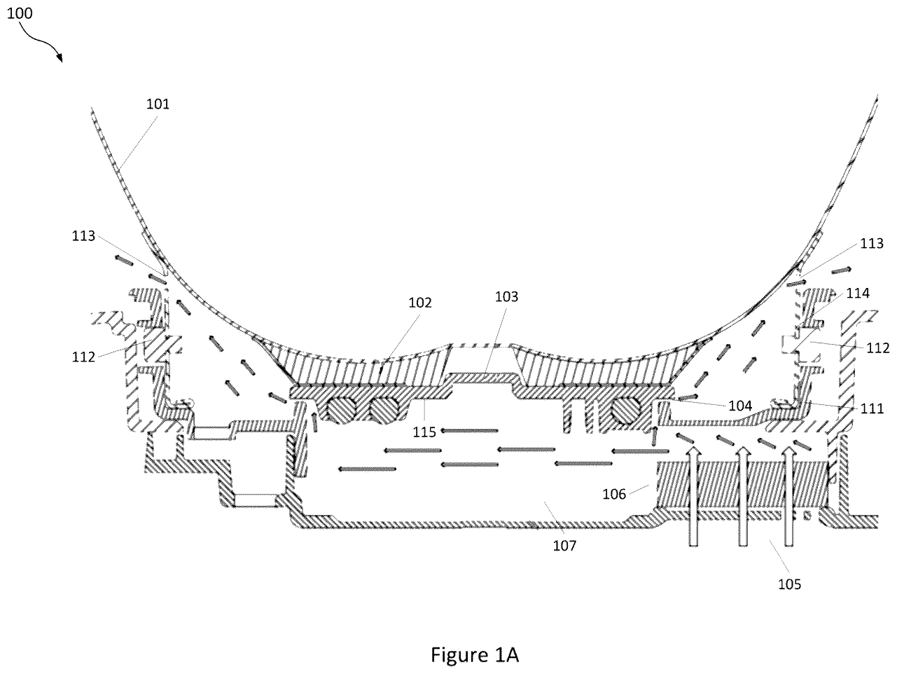

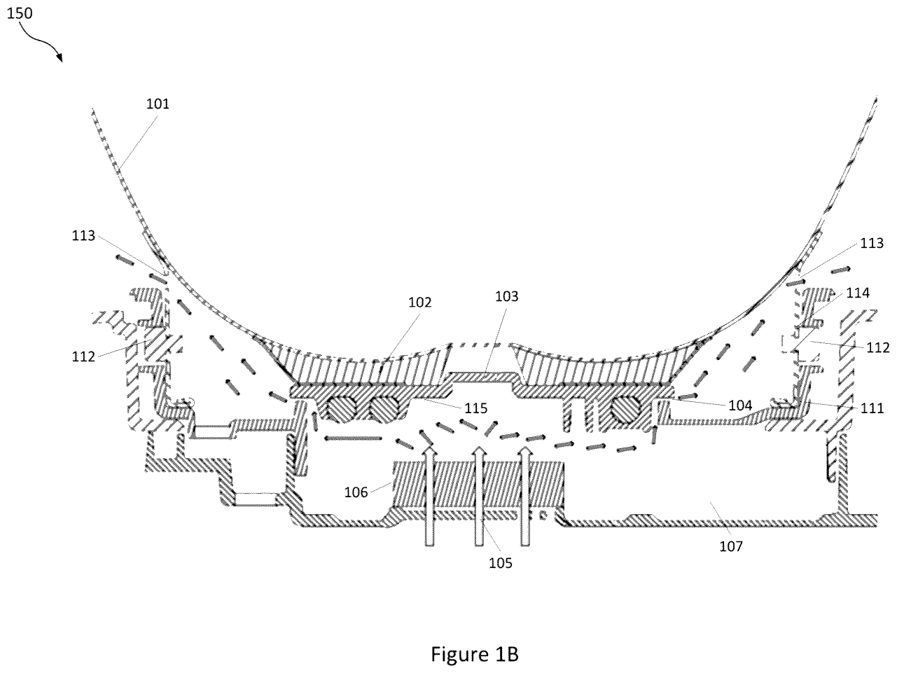

FIGS. 1A and 1B are side-on cutaway drawings of heating arrangements;

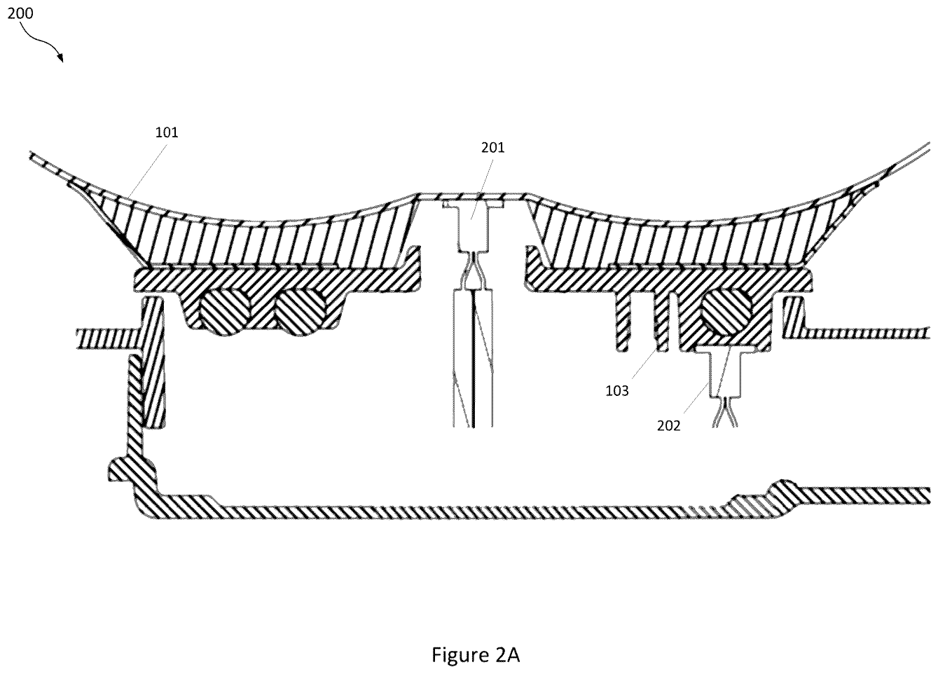

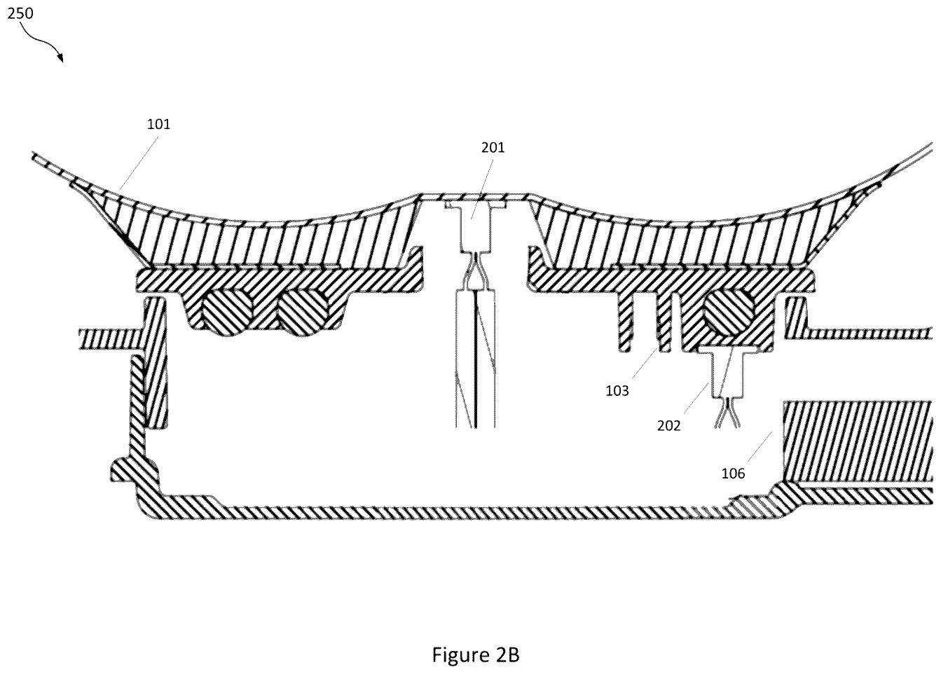

FIGS. 2A and 2B are side-on cut-away drawings of a further heating arrangement;

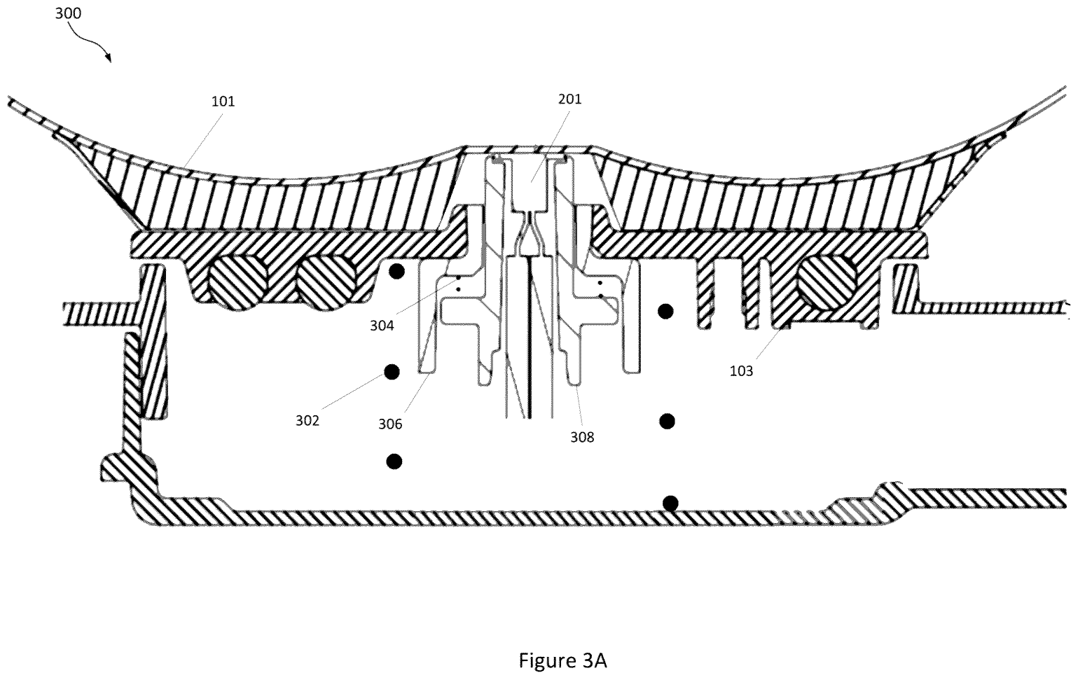

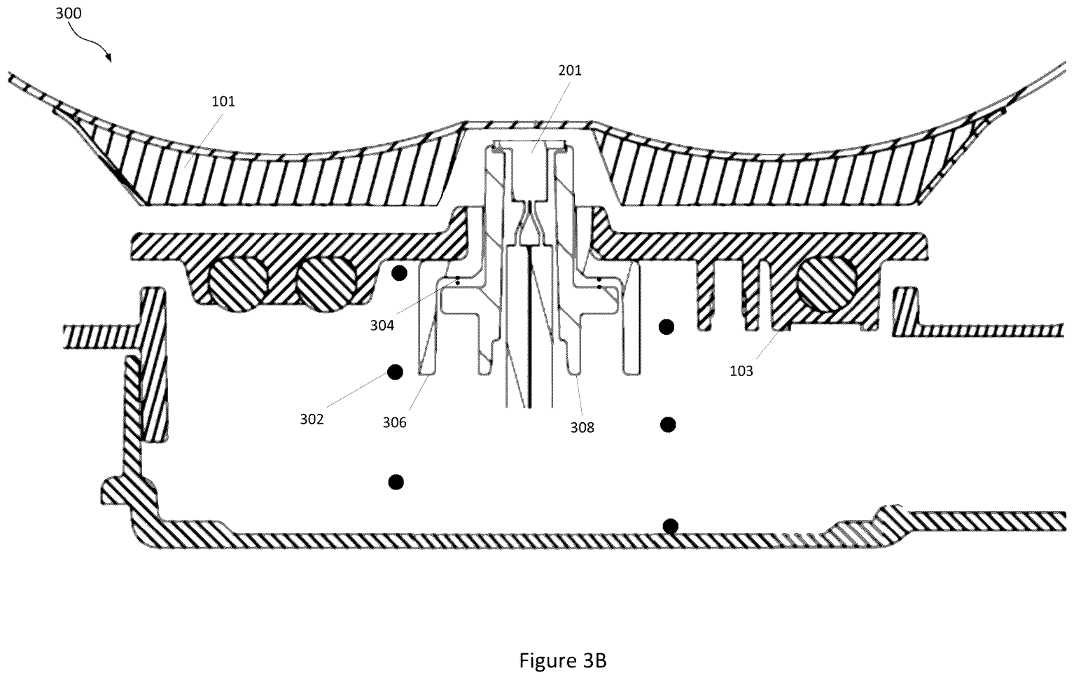

FIGS. 3A and 3B are side-on cutaway drawings of a further heating arrangement;

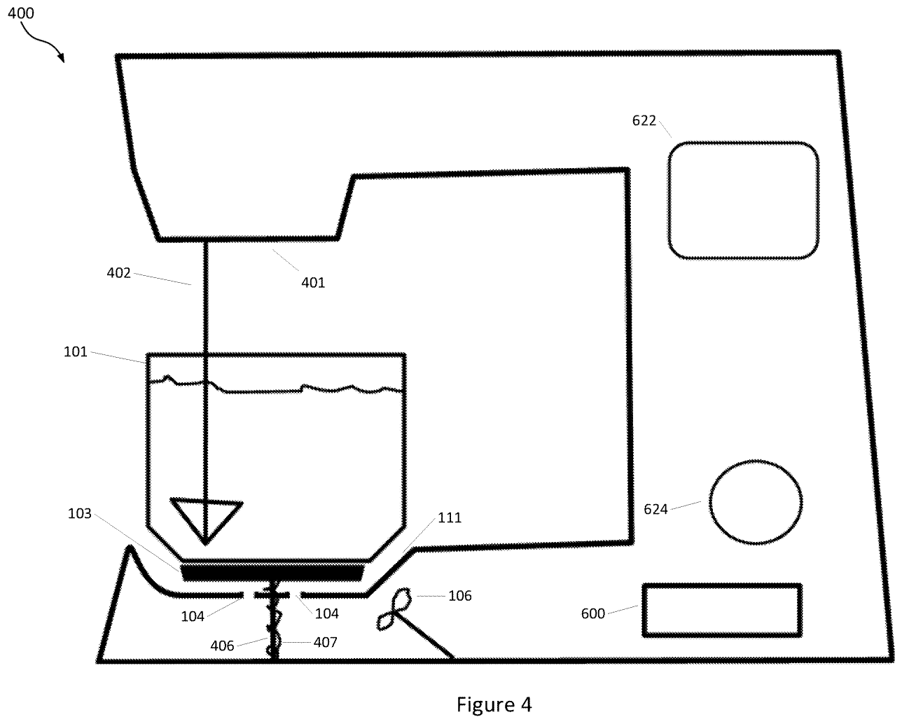

FIG. 4 is a side-on schematic drawing of a cooking appliance;

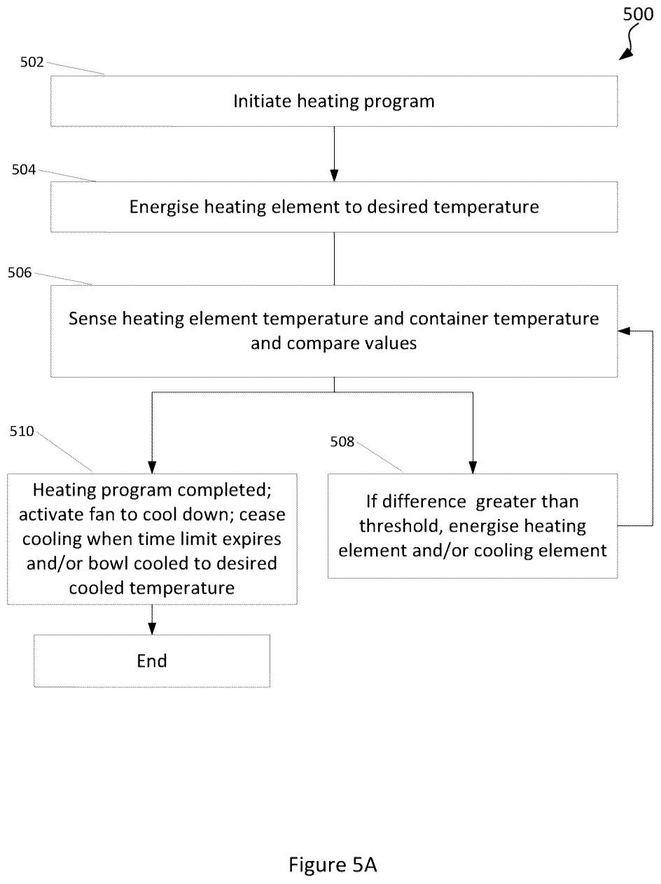

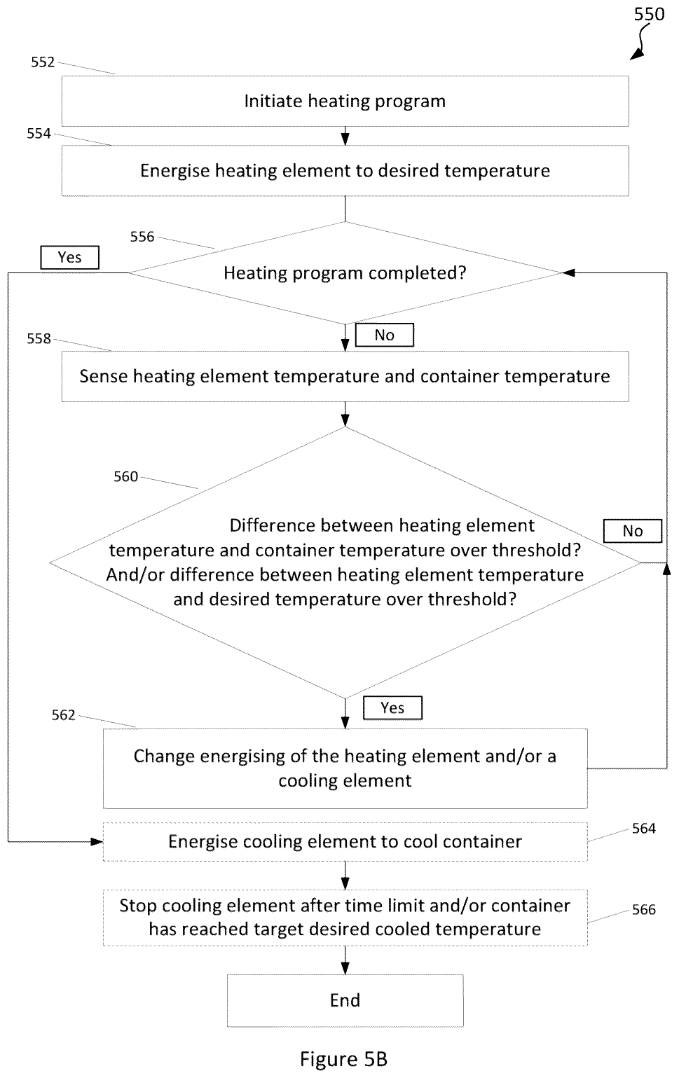

FIGS. 5A and 5B are flow-charts of cooking processes to be carried out; and

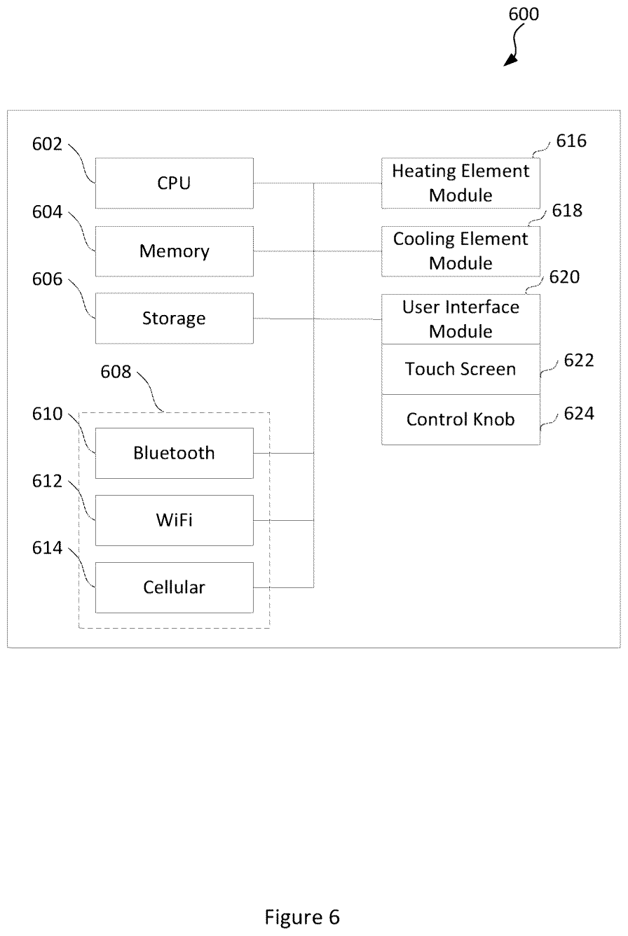

FIG. 6 is a schematic diagram of a controller configured for use with a number of the preceding embodiments.

FIG. 1A and FIG. 1B illustrate heating arrangements 100, 150 for a cooking appliance in which a container 101 having an additional thermal mass 102 is heated by a heating element 103 (which may also have its own thermal mass 115). The container 101 is retained in a container receiving member 111 by releasable locking-elements 112 which are retractably inserted through holes in a container stand 114 of the container 101. As such, the container 101 is releasably retained in the container receiving member 111. The container rest 114 is in the form of an additional frame surrounding the base of the container 101 which can be used to support the bowl when it is independently stood on a table or other similar surface.

The container receiving member 111 preferably abuts the container 101 with a gap of 1 cm or less, and more preferably conforms to the neighbouring external shape of the container 101 with a minimum gap of 1 cm or less, for guiding the air-flow over the surface of the container 101.

The container 101 in this example is a bowl. Alternative container shapes and configurations may also be possible including in the form of a closed topped bowl, a plate, and/or griddle.

The heating arrangement 100 optionally comprises an interlocking system comprising the locking-elements 112 and an interlock detection means (not shown). The interlock system allows the container 101 to be locked or unlocked when in the container receiving member 111. When locked in, the container 101 is in a position such that the heating element 103 is urged against the container 101. The interlocking system is configured to permit activation of the heating element 103 and/or cooling element 106. The interlock detection means is a micro switch such that, only when the container is received, the micro switch is depressed (or vice versa). The interlock detection means may instead or additionally be based on a resilient element being urged against the container. Alternatively, a connection between the heating element 103 and/or cooling element 106 and a controller and/or a connection between the heating element 103 and/or cooling element 106 and a power source is physically disconnected when the container is not locked in.

Alternatively, the container 101 is releasably retained in the container receiving member 111 by a friction fit. In this alternative, the container receiving member 111 is sized such that the when the container 101 is placed in the container receiving member 111, the friction fit forms and the user can remove the container 101 by lifting it out and overcoming the force of the friction fit.

Preferably, the heating element 103 is configured such that with the container 101 not received within the container receiving member 111, the annular gap is fully open. Alternatively, the heating element 103 is configured such that with the container 101 not received within the container receiving member 111, the annular gap is fully closed.

FIG. 1A and FIG. 1B show exemplary embodiments where both the container 101 and the heating element 103 comprise thermal masses 102 and 115 respectively. Alternatively, the heating element 103 does not comprise the thermal mass 115. While the container 101 is shown with a large thermal mass 102, alternatively, the thermal mass 102 of the container 101 may be substantially less than shown.

The thermal mass 102 of the container 101 may be formed of Aluminium for its high heat conductivity, with the Aluminium thermal mass 102 preferably coated or surrounded by stainless steel contiguous with that of the container 101 for attractiveness and to ensure the material of the thermal mass 102 is contained within a food-safe surrounding. However, another material of similar or greater conductivity may be used for the thermal mass 102, including Copper. Optionally, the thermal masses 102, 115 are made of a material of approximately 200 W/mK or greater. Preferably, the thermal masses 102, 115 are at least 5 mm thick. Having a thickness of at least 5 mm is to ensure good heat-spreading. Both Aluminium and Copper are relatively easily worked and cheap materials. The thermal mass 115 of the heating element 103 may be similarly formed, or alternatively may be omitted.

The thermal mass 102 preferably conforms on its upper side to the outer skin of the container 101, and on its lower side to the heating element 103 and/or its thermal mass 115. In this way good thermal transfer from the heating element 103 to the container 101 is ensured.

A central aperture is formed through the thermal masses 102, 115 via which a sensor can contact the bottom of the container 101. With an aperture through the thermal mass 102 of the container 101 it is possible to obtain a more accurate measurement of a property (such as temperature) of the contents of the container 101 rather than the thermal mass 102 of the container 101. Optionally, a further central aperture is formed through the thermal mass 115 of the heating element 103 via which a sensor can pass.

To overcome the problem of latent heat in the thermal mass 102 of the container 101, in the heating element 103, in the thermal mass 115 of the heating element 103, and/or in the contents of the container 101 a cooling element 106 is used. The cooling element 106 is configured to cool the thermal masses 102, 115.

The cooling element 106 is situated in an airbox 107 under the heating element 103. As indicated by the air-flow arrows in FIG. 1A and FIG. 1B, when activated the cooling element 106 moves air along a fluid flow-path from outside of the airbox 107 (via fluid entrance holes 105), past and around the heating element 103 and over the outer skin of the container 101. The configuration of the heating element 103 and container receiving member 111 is such that, with the container 101 in situ, there is an annular airgap 104 between the container receiving member 111 and the heating element 103, allowing air to flow from one to the other, and eventually to the external environment via the exhaust holes 113.

As herein described the cooling element 106 is a fan. Alternatively any other suitable cooling element 106 could be used, including other fluidic cooling elements (e.g., water cooling, a compression circuit etc.), though direct cooling elements (for instance where a flow of gas or liquid impinges directly on the objects to be cooled) are preferred because of their faster response-time. Fans are advantageous as they do not require the provision of a separate cooling medium (unlike, e.g., a water-cooling system) since their cooling medium comes from the surrounding atmosphere, thus rendering them relatively cheap and simple. In the preferred embodiment, the control and construction of the fan are further simplified by controlling the fan using only on/off control. As such the fan only has one speed.

Providing the cooling element 106 within the heating arrangement 100, which is within the appliance, and below the heating element 103, maximises both the compactness of the appliance, and (given the planar nature of the heating element, with the upper major surface contacting the container 101 and its thermal mass 102) the area to be cooled.

With the container 101 in situ, and at the end of a heating cycle/programme, the cooling element 106 can be either automatically activated by a pre-programmed recipe, or manually controlled by the user to pass air over and around the heating element 103 (and container 101) to cool the thermal mass 102 to a prescribed temperature. The cooling element 106 can be activated for a given period of time and/or until the heating element 103 and/or the container 101 are at a given temperature.

Testing has shown that the time to cool can be halved using this forced air cooling method, as opposed to passive cooling to ambient without a fan. Using the same cooling element 106 to cool both the heating element 103 and the container 101 additionally has the advantage of providing cooling for both the heating element 103 and the container 101 from a single source.

As described above, the cooling element is configured to cool the container 101 and the heating element 103 (and their thermal masses 102, 113). This can be considered a “cooling” mode of operation. The cooling element 103 is also configured to be used simultaneously with the heating element 103 to promote thermal transfer from the heating element 103 to the container 101 and along the walls of the container 101. This can be considered a “transfer” mode of operation. The heat is transferred from the heating element 103 to the container 101 in a sustained manner, preferably such that the container 101 is not cooled by the cooling element 106. By way of example here, the cooling element 103 is a fan. In this case, the fan speed for promoting heat transfer is different to that for cooling; for example it may be slower so as to allow the air driven by the fan to rise to the desired temperature (e.g., 25-70 degrees centigrade for e.g., melting butter or chocolate) before it contacts the container 101. The transfer mode can be used where a significant temperature difference between the heating element 103 and the container 101 is detected (e.g., more than 5 degrees, and preferably more than 1 degree centigrade) and optionally when the container 101 is lower than a desired temperature. The transfer mode is activated to promote thermal transfer from the heating element 103 to the container 101. Movement of a stir-tool simultaneous with heating may further promote heat transfer throughout the material being heated and along the skin of the container 101.

By configuring the cooling element 106 to impinge on the heating element 103 first and the container 101 second, the “transfer” mode of the cooling element is enabled.

Alternatively to the heating element 103 being separate from the container 101 as shown in FIG. 1A and FIG. 1B, the heating element 103 is integral to the container 101. In this alternative embodiment, a power connection is made to the container 101 to energise the heating element 103. Optionally, power is connected only when the container is received in the container receiving member 111. Advantageously, with an integral heating element 103, the heat transfer between the heating element 103 and the container 101 and therefore the contents of the container 101 is improved. Preferably, the heating arrangement 100 of this example comprises the locking-element 112 as previously described and the power connection only connects when the container 101 is locked in.

Preferably, the heating element 103 is spring-loaded into contact with the container 101 via a centrally-located coil-spring wrapped around a guide (not shown in FIG. 1A or FIG. 1B). This ensures close contact between the two and promotes thermal transfer between the two, reproducing the advantages of the container 101 having an integral heating element, or providing induction heating of the container 101, without the additional expense of this. Use of this spring-loading arrangement also results in the gaps 104 between the container receiving member 111 and the heating element 103 through which air may flow for cooling by virtue of the heating element 103 being urged away from the container receiving member 111.

Referring to FIG. 2A and FIG. 2B, heating arrangements 200, 250 are shown. In these heating arrangements 200, 250, the problem of thermal overshoot is addressed by providing a container temperature sensor 201, a heating element temperature sensor 202 directly onto the underside of the heating element 103, and a controller 600 (not shown in FIG. 2A or FIG. 2B) operatively coupled to the temperature sensors. These two temperature sensors 201, 202 allow for differential analysis of the container 101 and heating element 202 temperatures to predict the behaviour of the container 101 contents.

FIG. 2A shows a heating arrangement 200 comprising a heating element 103. FIG. 2B shows a heating arrangement 250 comprising a heating element 103 and a cooling element 106. The embodiment as shown in FIG. 2B may be used in combination with the embodiment as herein described with reference to FIG. 1A or FIG. 1B.

The container temperature sensor 201 is configured to measure the temperature of the container 101. The heating element temperature sensor 202 is configured to measure the temperature of the heating element 103. The heating element temperature sensor 202 is optionally placed directly onto the underside of the heating element 103. In this example, the temperature sensors are Negative Temperature Coefficient (NTC) sensors.

In particular they are NTC thermistors. Alternatively, the temperature sensors 201, 202 may be any one or more and in any combination of:
infra-red;
positive thermal coefficient (PTC) thermistors;
resistance temperature detectors;
thermocouple; and/or
semiconductor based.

In the example where the sensors are NTC thermistors, the sensors further comprise support electronics to convert the resistance of the NTC thermistors to a useful voltage for reading by the controller. Example support electronics include a Wheatstone bridge.

The controller 600 is configured to read the temperature of the heating element 103 and the container 101, and optionally energise the heating element 103 and/or the cooling element (if present, i.e. the sensing arrangement of FIG. 2B) based on the temperatures measured and/or the difference between the temperatures.

If the difference between the temperature sensed by the container temperature sensor 201 and the heating element temperature sensor 202 is great, the controller increases the power delivered to the heating element 103 to compensate for this difference, reducing and/or cycling power to the element once parity and the target temperature is met.

Likewise, if the heating element 103 temperature is higher than the container 101 temperature and/or the desired temperature, action is taken to reduce the element temperature until parity is met between the container 101 and the heating element 103.

This action may or may not include operation of the cooling element 106. A more detailed example method of controlling the energising the cooling element 106 and/or heating element 103 for cooking based on differential analysis is described with respect to FIG. 5A and/or FIG. 5B.

Referring to FIGS. 3A and 3B, a further heating arrangement 300 is shown. The container temperature sensor 201 and the heating element 103 are held spring-loaded against the container 101. This ensures good thermal transfer between the two and thus increases the accuracy of temperature readings. This may be achieved either by mounting the container temperature sensor 201 fixedly on the heating element 103, with the heating element 103 being spring-loaded against the container 101, or by providing the container temperature sensor 201 with independent spring-loading.

In particular, the heating arrangement 300 comprises a number of similar or the same members as herein described with reference to other example heating arrangements 100, 200, 250 of FIGS. 1A, 1B, 2A, and 2B. Except where explained below, the same reference numerals are used to refer to similar or the same features. The heating arrangement 300 comprises a container 101, a heating element 103, a container temperature sensor 201, and an urging mechanism comprising two resilient elements 302, 304, a sensor guiding member 306, a sensor mounting member 308 The sensor guiding member 306 is integral or attached to the heating element 103. In this example, the resilient elements 302, 304 are coil springs. The two resilient elements 302, 304 can be described as cascading resilient elements or cascading springs as the movement/force is passed from one to the other in a cascading manner.

The first resilient element 302 is operatively coupled between the heating element 103 and the heating arrangement 300. The first resilient element 302 is a compression resilient element such that it is configured to compress when the load of the container 101 is applied to it via the heating element 103.

The second resilient element 304 is operatively coupled between the heating element 103 (via the sensor guiding member 306 and the sensor mounting member 308) and the container temperature sensor 201. The second resilient element 304 is a tension resilient element such that it is configured to stretch when the load of the container 101 is applied to it via the container temperature sensor 201 and the sensor guiding member 306.

The urging mechanism is configured such that the container 101 engages with the container temperature sensor 201 first, before the container 101 engages with the heating element 103. The spacing between the sensor guiding member 306 and the sensor mounting member 308, the size of the second resilient element 304, and the size of the different components of the urging mechanism allow this configuration.

The stiffnesses of the resilient elements 302, 304 are selected such that when the container 101 initially engages with the container temperature sensor 201 the second resilient element 304 is configured to extend without substantially moving the heating element 103 via the first resilient element 302. The second resilient element 304 has a lower stiffness than the first resilient element 302.

The urging mechanism is configured to urge both of the temperature sensor 201 and the heating element 103 against the container 101. Urging the temperature sensor 201 and the heating element 103 against the container 101 improves thermal transmission between these members 201, 103 and the container. With regards to the sensor 201, the ability for the sensor 201 to measure the temperature of the container 101 more accurately is improved via the urging mechanism. With regards to the element 103, the ability for the element 103 to transfer heat to the container 101 is improved via the urging mechanism.

The same urging mechanism (and also the same resilient element 302) is used to urge both the temperature sensor 201 and the heating element 103 against the container 101. Using the same urging mechanism for both thereby reduces component cost at no substantial cost of accuracy of temperature measurement and/or heating ability.

A central guide rod (or rods) (not shown) may be used to keep the resilient element(s) 302, 304 in place and in particular the resilient element 302 sits over the guiding rod. The cooking appliance 400 of FIG. 4 uses this example guiding rod 406.

The heating element 103 is also held within the heating arrangement 300 by a heating element retainer member (not shown) such that the heating element 103 cannot accidentally be removed or dislodged from the heating arrangement 300.

Referring to FIG. 3A, the urging mechanism is shown in an engaged position where the container temperature sensor 201 and the heating element 103 are engaged with the container 101 and the container 101 is completely received in a container receiving member (not shown) and therefore received in the heating arrangement 300. Optionally, the container receiving member in this example is the same container receiving member 111 as described with reference to FIG. 1A or FIG. 1B. The first resilient element 302 is in a compressed state and the second resilient element 304 is in an extended state. Preferably, the container temperature sensor 201 is received in a recess defined by the container 101 to maximise sensor effectiveness. The container temperature sensor 201 ideally directly contacts the skin of the container 101, such that there is only one layer of material (the skin) between the sensor 201 and the interior of the container 101.

Referring to FIG. 3B, the urging mechanism is shown in an unengaged position. The resilient element 302 is in a fully extended position. In this fully extended position, the heating element 103 is retained at a maximally extended position by the heating element retainer member (not shown). The sensor mounting member 308 is also minimally extended (or maximally compressed) and therefore the container temperature sensor 201 is also maximally extended. The sensor mounting member 308 abuts the heating element 103 indirectly via the sensor guiding member 306.

A number of the components of the urging mechanism are made from heat insulating materials. This is to ensure the heat generated by the heating element 103 does not (or at least limits any) influence the container temperature measurements by the sensor 201. Further, with the sensor guiding member 306 and the sensor mounting member 308 as two separate components, heat transfer between the sensor 201 and heating element 103 is further reduced.

Additionally the heating arrangement 300 of FIGS. 3A and 3B may further comprise an interlocking system (not shown). The interlocking system comprises a bayonet mount. The container 101 comprises the male component of the bayonet mount and the heating arrangement comprises the female component. The first resilient element 302 acts as the resilient element of the bayonet mount. Optionally, the interlock system comprises an interlock detection means as herein described.

Referring to FIG. 4, an embodiment of the invention implemented in a stand-mixer 400 is shown. The stand mixer 400 has a tool-mount 401 connected to a motor (not shown) to which a tool 402 may be removably attached and driven to rotate, for example driven to rotate in planetary fashion. When the tool 402 is in use it depends from the tool mount 401 into a container 101 located in a container receiving member 111 of the stand-mixer 400, the container 101 being filled with a working medium (e.g., chocolate) on which the stand-mixer carries out food processing operations (e.g., heating, stirring, blending etc.). The container 101 is retained in the bowl-seat by locking elements (not shown).

To heat the container 101 and its contents a heating element 103 is mounted on a guide rod 406 and held in contact with the container 10130 by a resilient element 407 (e.g., a coil spring) to ensure good heat transfer. A cooling element 106 (in particular a fan) provides air-flow around both the heating element 103 and, via apertures 104, around the outer surface of the container 101 as described with reference to FIG. 1A and FIG. 1B.

A controller 600 is provided in the stand mixer 400 in electronic communication with temperature sensors (not shown) such as the NTCs discussed above. The controller is also in electronic communication with the motor of the stand mixer 400, the heating element 103, the cooling element 106, a control knob 624 and a touch-screen interface 622. The controller 600 may control the cooling element 106 and heating element 103 to heat and cool the container 101 in the fashion discussed above and/or responsive to a program selected by the user using the touch screen interface 622 and/or the control knob 624 and/or according to instructions received via a wireless communications link (e.g., WiFi, not shown) to the Internet.

As an additional safety feature, the controller 600 may receive feedback from a sensor (e.g., a push-rod and micro-switch arrangement) configured to detect whether or not the heating element 103 is pushed down by the container 101. In this way the controller 600 may prevent the heating element 103 being energised when the container 101 is not located in the container receiving member 111 so as to depress the heating element 103 against the urging of the spring 407.

In this cooking appliance 400 comprises a heating arrangement similar to that as described with reference to FIGS. 3A and 3B.

The example, cooking appliance 400 shown in FIG. 4 can be configured for use with any one or more of the preceding heating arrangements 100, 150, 200, 250, 300. Preferably, the cooking appliance 400 comprises the heating arrangement 100 as described with reference to FIG. 1A. More preferably, the cooking appliance 400 further comprises the heating arrangement 250 of FIG. 2B. And even more preferably, the cooking appliance further comprises the heating arrangement 300 of FIG. 3.

The cooking appliance 400 is configured to receive data indicative of at least one recipe. The recipe is stored on the cooking appliance 400. Alternatively, the user provides the recipe to the cooking appliance 400 by the user interface (selecting different temperatures and times) or by a smartphone application and transmitted to the cooking appliance via a short range wireless communication (i.e. Wi-Fi or Bluetooth®). The recipe comprises a desired cooking temperature(s) and an end condition for when the cooking time is over.

Example heating programs 500, 550 are shown in FIGS. 5A and 5B. A controller 600 as described with reference to FIG. 6 is configured to undertake the heating programs 500, 550 as herein described.

Referring first to FIG. 5A, in this cooking process 500, in a first step 502 a heating program is initiated. Responsive to the heating program being initiated, in the second step 504 a heating element 103 is energised to achieve a desired temperature (e.g., 70 degrees centigrade) based on feedback from a sensor (e.g., NTC) associated with the heating element 103. In a third step 506 a temperature difference is measured between the heating element 103 and the container 101 based on feedback from sensors associated with each of them. While the desired temperature in this example is the desired temperature of the heating element 103, in an alternative example the desired temperature may be that of the container 101 instead. In this alternative, the heating element 103 is energised such that the desired temperature of the container 101 is reached instead. Responsive to the temperature difference exceeding a predetermined amount (e.g., 5 degrees, and more preferably 2 degrees, and more preferably still 1 degree centigrade), a fourth step 508 is initiated where the heating element 103 and/or cooling element 106 are energised to correct the disparity and bring the temperatures closer together and to the desired temperature. A motor driving a stir-tool may also be energised to promote the spread of heat throughout the bowl-contents.

For example, where the temperature of the container 101 is below a desired temperature, the cooling element 106 operates in a transfer mode to move heated air from around the heating element 103 toward the container 101 thus warming the container 101. The heat transfer is conducted such that the heating element 103 is still capable of heating the air surrounding it to the desired temperature. Additionally or alternatively, the output of the heating element 103 may be increased to raise the container 101 to the desired temperature. In a further alternative, where the temperature of the heating element 103 is excessive, the cooling element 106 is activated in a cooling mode to cool it. In the example where the cooling element 106 is a fan, the fan operating at a speed and volume of air that removes heat from the heating element 103 faster than it is replaced.

Once the temperature disparity is corrected in the fourth step 508, there is continued maintenance of the temperature of the heating element 103 and/or container 101 at temperatures within a desired range (e.g., 25-70 degrees centigrade—a temperature suitable for, e.g., melting chocolate or butter, or proving dough).

To check when the heating program has completed, an end condition is checked. Example end conditions are:
a total time of the heating program has elapsed,
a total time the heating element has remained at the desired temperature has elapsed,
a total time the container has remained at the desired temperature has elapsed, the heating element has achieved a certain temperature,
a certain number of rotations by a cooking appliance tool 402 (as measured by, for example, a hall sensor associated with an axle which the tool 402 receives rotary impetus from),
a torque sensor associated with the tool 402 indicating that a desired thickness of the contents (e.g. dough) has been achieved,
some other sensory input, and/or
a user chooses to end the heating program.

Once the heating program has completed a fifth step 510 is then initiated in which the fan is run at a speed suitable for removing the heat from the container 101 and from the heating element 103to render both safe and to cool the contents of the container 101 to a desired temperature.

The fifth step 510 may continue until either a predetermined time has elapsed or feedback from sensors indicates that the container 101 and/or heating element 103 has/have reached a desired temperature.

In an alternative program, the absolute temperature of the heating element and/or container 101 may be sensed in the third step 506 alternatively or additionally to the temperature difference between the two, and compared to a desired temperature. If the absolute temperature differs from the desired temperature by more than a predetermined amount (e.g., 5 degrees, preferably 2 degrees, and more preferably 1 degree centigrade) then the fourth step 508 is initiated to bring the temperature difference back within the predetermined amount.

Referring to FIG. 5B, a cooking process 550 similar to the cooking process 500 as herein described with reference to FIG. 5A is shown. In this example of the cooking process 550

In a third step 556, there is a check as to whether the heating program has completed. The same end conditions as described with reference to FIG. 5A are checked to determine if the heating program has completed.

The third step 556 is the start of a loop and is repeatedly checked throughout the cooking process (unless the heating program has completed once the heating element is at the desired temperature the first time). Alternatively, the third step 556 is conducted asynchronously with the remainder of the steps. In this alternative, if the heating program has completed, it will halt the remaining steps 558, 560, 562 relating to measuring temperature and proceed to the end of program related steps 564, 566.

In a fourth step 558, the temperature of the container 101 and the heating element 103 are measured. The temperature of the heating element 103 and container 101 are measured using temperature sensors 201, 202.

The difference between the heating element temperature and the container temperature is calculated. Additionally, the difference between the heating element temperature and the desired temperature is calculated. The difference is calculated by taking the absolute of one temperature minus the other.

If either temperature difference is not over a threshold then the cooking program moves back to step 556 where there is a check to see if the heating program has completed, or if the step 556 is not part of the loop, then the heating element temperature and the container temperature are sensed again. Optionally a sleep timer is used between sensing the temperatures such that the CPU of the controller isn't pegged.

If either temperature difference is over a threshold value then, in a fifth step the energising of the heating element 103 and/or the cooling element 106 is changed. This can also be described as energising the heating element 103 and/or cooling element 106 to a different energy level. Changing the energy level of the heating element 103 (or the amount the heating element 103 is being energised) changes how much heat the heating element 103 puts out. Changing the energy level of the cooling element 106 (or the amount the cooling element 106 is being energised) changes the amount of heat that is being transferred. In the example where the cooling element 106 is a fan, the greater the energisation, the faster the fan will spin.

Preferably, the temperate difference threshold in the step 560 is 5 degrees centigrade. More preferably, the temperate difference threshold in the step 560 is 2 degrees centigrade. Even more preferably, the temperate difference threshold in the step 560 is 1 degree centigrade. The temperature difference threshold in this example is associated with the heating program. Alternatively, the temperature difference threshold is user set.

Preferably, the amount the heating element 103 and/or cooling element 106 are energised is proportional to the temperature difference. For example, if the difference is greater, then the amount the heating element 103 and/or cooling element 106 are energised is greater. Alternatively, the heating element 103 and/or cooling element 106 are energised completely on or completely off (in particular, completely on if the temperature difference exceeds the threshold and completely off if the temperature difference is less than the threshold). This alternative control can also be considered bang-bang control.

Preferably, the cooling element 106 is a fan capable of operating at a single speed. In this case, only bang-bang (i.e., on/off) control is possible. In some situations it is preferable to energise the fan (at its only speed) at the same time as the heating element 103 is being energised. Preferably, the fan and heating element 103 are energised at the same time to assure controlled heating of the container 101. Having the fan and heating element 103 both on provide an intermediate temperature level between a cooking and cooling mode. This intermediate level may be a warming mode. If the single speed of the fan is low enough, then the fan and heating element 103 may be energised at the same time to ensure good thermal transfer between the heating element 103 and the container 101 such that the fan moves hot air from around the heating element 103 and around the container 101.

The example energising changes discussed in the following paragraphs may all be used in the same example cooking process 550. Alternatively, only some steps are used. Some or all of these steps are used to assist maintaining the container 101 and heating element 103 within an acceptable range of each other and to assist in maintaining the heating element 103 at the desired temperature to cook the contents of the container 101 according to the provided heating program or recipe.

As an example of how the energising of the heating element 103 and/or cooling element 106 changes: if the heating element temperature is higher than the desired temperature and the difference between the two temperatures exceeds a threshold then the amount the heating element 103 is energised is reduced and/or the amount the cooling element 106 is energised is increased.

As a further example of how the energising of the heating element 103 and/or cooling element 106 changes: if the heating element temperature is lower than desired temperature and the difference in temperatures exceeds the threshold amount then the amount the heating element 103 is energised is increased and/or the amount the cooling element 106 is energised is reduced.

As a further example of how the energising of the heating element 103 and/or cooling element 106 changes: if the heating element temperature is higher than container temperature and the difference in temperatures exceeds the threshold amount then the amount the heating element 103 is energised is reduced and/or the amount the cooling element 106 is energised is increased.

As a further example of how the energising of the heating element 103 and/or cooling element 106 changes: if the heating element temperature is lower than the container temperature and the difference of the temperatures exceeds a threshold amount, then the amount the heating element 103 is energised is increased and/or the amount the cooling element 106 is energised is reduced.

When this cooking process 550 is used with a heating arrangement that does not comprise a cooling element 106 (for example as with the heating arrangement 200 of FIG. 2A), similar steps are taken except instead of using the cooling device 106, passive cooling is used and/or the heating element 103 is less aggressively energised.

As a further example of how the energising of the heating element 103 and/or cooling element 106 changes: if the heating element 103 is within the temperature threshold of the desired temperature and the temperature of the container 101 is lower than the heating element 103 and the difference between the temperature of the container 101 and the heating element 103 exceeds a threshold temperature, the cooling element 106 is energised at a low level. This low level is used to assist in transferring heat from the heating element 103 to the container 106.

With any temperature disparities corrected, the temperature control steps loop such that the temperatures are maintained within the desired range set by the heating program or recipe (e.g., 25-70 degrees centigrade—a temperature suitable for, e.g., melting chocolate or butter, or proving dough). The temperatures are maintained until the heating part of the heating program has completed.

Returning to the third step 556 of checking whether the heating program has completed, if the heating program has completed, the ending step(s) will start.

Optionally in a step 564, if a cooling element 106 is present, the cooling element 106 will be energised to remove the heat from the container 101 and from the heating element 103. The heat is removed from both to render both safe to touch and to cool the contents of the container 101 to a second desired temperature. In a step 566 the cooling element 106 is de-energised after a predetermined time of cooling and/or after the container 101 and/or heating element 103 has/have reached the second desired temperature.

The cooking processes 500, 550 as described with reference to FIGS. 5A and 5B can be implemented, at least in part, using computer program code. The computer program code is configured to run on the controller 600 of the cooking appliance 400 or the controller 600 of any of the preceding heating arrangements.

Referring to FIG. 6, in common with a general electronic consumer apparatus, each controller 600 comprises a Central Processing Unit (CPU) 602, memory 604, storage 606, communication interface module 608, a heating element module 616, an optional cooling element module 618, and an optional user interface module 620 in communication with one another via a communication bus. The communication interface module 608 comprises any one or more of a Bluetooth controller 610, a Wi-Fi controller 612, and/or a cellular controller 614. Alternatively, no communication interface module 608 is used and the controller does not communicate with any external devices.

The CPU 602 is a computer processor, e.g. a microprocessor. It is arranged to execute instructions, e.g. in the form of computer executable code, and to process data, e.g. in the form of values and strings, including instructions and data stored in the memory 604 and the storage 606. The instructions and data executed by the CPU 602 include instructions for coordinating operation of the other components of the controller, such as instructions and data for controlling the communication interface module 608 and the user interface module 620.

The memory 604 is implemented as one or more memory units providing Random Access Memory (RAM) for the controller 600. In the illustrated embodiment, the memory 604 is a volatile memory, for example in the form of an on-chip RAM integrated with the CPU 602 using System-on-Chip (SoC) architecture. However, in other embodiments, the memory 604 is separate from the CPU 602. The memory 604 is arranged to store the instructions and data executed and processed by the CPU 602. Typically, only selected elements of the instructions and data are stored by the memory 604 at any one time, which selected elements define the instructions and data essential to the operations of the controller 600 being carried out at the particular time. In other words, the instructions and data are stored transiently in the memory 604 whilst some particular process is handled by the CPU 602.

The storage 606 is provided integrally with the controller 600, in the form of a non-volatile memory. The storage 606 is in most embodiments embedded on the same chip as the CPU 602 and the memory 604, using SoC architecture, e.g. by being implemented as a Multiple-Time Programmable (MTP) array. However, in other embodiments, the storage 606 is an embedded or external flash memory, or such like.

The storage 606 stores the instructions and data executed and processed by the CPU 602. The storage 606 stores the instructions and data permanently or semi-permanently, e.g. until overwritten. That is, the instructions and data are stored in the storage 606 non-transiently. Typically, the instructions and data stored by the storage 606 relates to instructions fundamental to the operation of the CPU 602, communication interface 608, user interface 620 and the controller 600 more generally, as well as to applications performing higher-level functionality of the controller 600 in the context of a cooking appliance. These applications more generally include instructions for controlling the heating element module 616 and/or the cooling element module 618 (if the cooling element 106 is present). The storage is configured to store heating programs or recipes.

The heating element module 616 and/or the cooling element module 618 are configured to control the energising of the element(s). The element(s) 103, 106 are energised using a number of different methods depending on the application. The simplest method is on-off where either maximum power or no power is supplied to the element 103, 106. Another method is to use Pulse Width Modulation (PWM) to achieve more finely grained control of the energising of the element 103, 106. A further method is to supply variable amounts of current and/or voltage to the element 103, 106. A person skilled in the art will appreciate that there are a number of ways of energising heating elements 103 or cooling elements 106 (if present) and the different techniques will depend on the requirements of the elements 103, 106 and/or accuracy. For example, when simply wanting to heat up the contents as hot as the heating element 103 will allow, the heating element 103 is simply turned on using maximum power. In other situations where finer control of the temperature and/or when there is a target temperature is need then PWM and/or variable voltage/current is used.

The heating element module 616 is further configured to permit activation of the heating element 103 responsive to the container 101 being received in the container receiving member 111. The heating element module 616 receives a signal that the resilient element is urged against the container 101 to determine if the container is received within the container receiving member 111.

The communication interface 608 supports short-range wireless communication, in particular Bluetooth® communication. The communication interface 608 is configured to establish the short-range wireless communication connection with a personal computing device (such as a user smart phone). The communication interface 608 is coupled to an antenna, via which wireless communications are transmitted and received over the short range wireless communication connection.

The user interface module 620 comprises optionally a touch screen display 622 and an input device in the form of a control knob 624. The display is alternatively a plurality of separate indicators, such as Light Emitting Diodes (LEDs). In other embodiments, the display is a screen, such as a Thin-Film-Transistor (TFT) Liquid Crystal Display (LCD) display or an Organic Light Emitting Diode (OLED) display, or other appropriate display. Alternatively, the input device is one or more user operable buttons, responsive to depression, toggling or touch by the user. The user interface module 620 is arranged to provide indications to the user, under the control of the CPU 602, and to receive inputs from the user, and to convey these inputs to the CPU 602 via the communications bus.

The heating element 103 of any of the embodiments herein described preferably has a maximum heat-output to the container 101 of less than 100 degrees centigrade, and preferably of less than approximately 95, 90, 80, 75, 70 65, 60, 55, 50, 45, 40, 35, or 30 degrees C., (i.e., medium-temperatures, higher than standard room-temperatures of 20-degrees C. but lower than those which necessarily burn/boil foods and beverages) and more preferably less than 70 degrees centigrade, to simplify construction and make it cheaper. This lower temperature also prevents the contents of the container 101 being heated to temperatures unsuitable for some specific cooking processes (e.g., chocolate tempering, dough proving, melting of butter etc.). The use of the different ways of coping with poor heat-transfer and temperature-differences between the heating element 103 and the container 101 discussed above means that a cheaper, resistive heating element can be used without loss of temperature-control accuracy. High temperature control accuracy (e.g., accuracy to within 1 degree of the desired temperature) also enables the carrying out of highly heat-sensitive operations, such as chocolate tempering and dough-proving.

The heating element 103 of any of the embodiments herein described preferably has a power rating of less than approximately 750 watts to assist in achieving a maximum heat-output such that the heating element 103 heats the container no higher than 100 degrees centigrade and preferably no higher than approximately 70 degrees centigrade. Preferably, the heating element 103 has a power rating of less than approximately 500 watts. More preferably, the heating element 103 has a power rating of less than approximately 300 watts, and optionally it has one of less than approximately 250 watts.

The power rating of the heater may be approximately 300 watts, as this has proved in trials to be capable of achieving medium-temperature food processing operations (e.g., proving dough, softening butter, chocolate tempering) in an effective and efficient manner when used in combination with accurate temperature control discussed above. This was particularly the case when used in combination with a metal bowl of 5-7 litres capacity, containing a food working-medium (e.g., Chocolate, butter, dough) of less than 1 kg, and more preferably less than 0.5 kg.

In overview, but for the present improvements, after heating operations the substantial thermal mass (the heating element and heating components of the bowl) might remain warm for a long period of time. This is shown to have a negative impact on some recipes, such as chocolate tempering, where the bowl contents needs to cool from a higher temperature (e.g. 35 degrees centigrade or higher) to a lower temperature (e.g. ambient) before proceeding with the recipe. This long cool-down of the thermal mass might also present risk where secondary bowls may be used in the bowl-seat in which the heating element is located, such as glass and plastic bowls which may be burned or cracked by the heat of the element. In situations where a quick change of recipe is required this retention of heat by the heating element and/or bowl may also cause problems—for example, where the user attempts to make buttercream icing, which requires room temperature equipment, straight after melting chocolate in the machine. The heating arrangements, processes, and cooking appliances herein described are configured to overcome these problems and cool the substantial thermal mass in appropriate time.

Similarly, the heating arrangements, processes, and cooking appliances herein described are configured to provide reduction of and/or completely prevent over-shoot of the element temperature, as the bowl-skin temperature and the temperatures of the thermal mass elements of the heating system are sensed. With differing thermal loads within the bowl, the rate of change of the temperature of the bowl skin will vary, but now with temperatures of the thermal mass elements of the heating system and the bowl-skin being sensed, there is a way of determining the effects different thermal loads have and to measure the temperature difference between the element and the bowl. The element no longer is required to continue heating until a pre-determined temperature is read by the bowl temperature sensor, which with a large thermal load in the bowl could result in a large disparity between element and bowl temperature.

In one embodiment, the heating element 103 may have a maximum output temperature of up to 150 degrees centigrade, preferably 100-150 degrees centigrade. The arrangement may be controlled to avoid the heating element exceeding this temperature (or another predetermined maximum temperature). For example, the heating element 103 may be controlled to carry out heating of the container 101 to e.g., 75 degrees by being energised to its maximum temperature (e.g., 150 degrees). Once the maximum temperature is reached by the heating element 103, this temperature may be sensed by the heating element temperature sensor 202, and the controller 600 may activate the cooling element 106 (e.g., activate a fan blowing hot air optionally towards and over the container 101 to further transfer heat to it) and optionally deactivate the heating element 103 until its temperature falls, for example to a temperature at most five degrees, and preferably four degrees below the maximum temperature (e.g., falls to 146 degrees). When this temperature has been reached, the heating element 103, if it has been deactivated, may be reactivated, and additionally the cooling element 106 may be deactivated. This cycle can be repeated until the container temperature sensor 201 detects that the desired temperature (e.g., 75 degrees) has been reached.

In a further embodiment, the cooling element 106 may be activated for example when the appliance 400 is determined to be in an inactive state by the controller 600 and a temperature of the heating element 103 (or alternatively container 101) is above a predetermined temperature such as a predetermined safe temperature. For example, this temperature may be 40 degrees (i.e., the temperature at which low-temperature burns become possible and which is unsuited for some unheated food preparation activities) or more. The controller 600 may detect an inactive state of the appliance 400 based for example on user instructions (i.e., being set to stand-by mode), the end of a recipe program being run on the controller 600, an inactive state of the motor of the appliance 400, the lack of a container 101 attached to the appliance, or other indicia. The controller 600 may then operate the cooling element 106 until the heating element 103 (and/or, optionally, container 101) has a temperature below the predetermined safe temperature, and preferably about 5 degrees below it. For example, the controller 600 may cause the cooling element 106 to activate until the heating element temperature 103 is 35 degrees or less (a temperature around a maximum likely in-door ambient temperature, and also suitable for non-heated food preparation activities). Once the desired temperature is reached, the cooling element 106 may be deactivated.

Each feature disclosed in the description, and (where appropriate) the claims and drawings may be provided independently or in any appropriate combination.

Reference numerals appearing in the claims are by way of illustration only and shall have no limiting effect on the scope of the claims.

1-25. (canceled)

26. A heating arrangement for a cooking appliance comprising:
a heating element;
a container;
a container receiving member; and
a cooling element configured to directly cool both the heating element and the container when the container is received in the container receiving member.

27. The heating arrangement of claim 26, wherein a fluid flow-path is defined when the container is received in the container receiving member, and preferably the cooling element is configured to drive fluid along the fluid flow path.

28. The heating arrangement of claim 27, wherein the fluid flow-path is defined by at least the heating element and the container, and preferably the fluid flow-path is defined by an outer surface of the container, and more preferably the fluid flow-path is guided around the outer surface of the container by the container receiving member.

29. The heating arrangement of claim 28, wherein the container receiving member and the heating element define a gap and the fluid flow-path is further defined by the gap, and preferably the gap is substantially annular.

30. The heating arrangement of claim 27, wherein the fluid driven along the fluid flow-path cools the heating element then the container.

31. The heating arrangement of claim 26, wherein the cooling element is a direct fluidic cooling element and preferably a fan, and more preferably the fan operates at a single speed when energised.

32. The heating arrangement of claim 26, wherein the container receiving member is configured to releasably receive the container.

33. The heating arrangement of claim 26 wherein the cooling element is configured to selectively operate in a cooling mode or a transfer mode, and preferably in the cooling mode both the heating element and the container are cooled, and preferably in the transfer mode heat is transferred from the heating element to the container in a sustained manner, and preferably in the transfer mode the cooling element is configured to promote thermal transfer between the heating element and the container.

34. The heating arrangement of claim 33, wherein in the cooling mode the cooling element operates at a first speed and in the transfer mode the cooling element operates at a second speed, and preferably the first speed is faster than the second speed.

35. The heating arrangement of claim 26, further comprising a thermal mass positioned between the heating element and the container, and preferably wherein the thermal mass is integral with the container.

36. The heating arrangement of claim 35, wherein the thermal mass comprises a material having a thermal conductivity of at least approximately 200 W/mK, and is preferably either Aluminium or Copper.

37. The heating arrangement of claim 26, further comprising:
a controller configured to:
determine a heating element temperature;
determine a container temperature; and
energise the heating element and/or the cooling element based on the heating element temperature and the container temperature, and preferably based on the difference between the heating element temperature and the container temperature.

38. A heating arrangement for a cooking appliance including a container, the heating arrangement comprising:
a heating element; and
a controller configured to:
determine a heating element temperature;
determine a container temperature; and
energise the heating element based on the heating element temperature and the container temperature, and preferably based on the difference between the heating element temperature and the container temperature.

39. The heating arrangement of claim 37, wherein the controller is further configured to receive a desired temperature, and preferably the energising of the heating element and/or a/the cooling element is further based on the desired temperature, optionally wherein the controller is further configured to energise the heating element to heat the container to the desired temperature.

40. The heating arrangement of claim 37, wherein energising the heating element and/or a/the cooling element is based on the difference between the container temperature and heating element temperature exceeding a threshold, preferably wherein the threshold is no more than approximately 5 degrees C., and preferably approximately between 5 and 1 degrees C., and more preferably wherein the predetermined difference is no more than 1 degree C.

41. The heating arrangement of claim 39, wherein the amount the heating element and/or a/the cooling element are energised is dependent on the difference between the container temperature and heating element temperature and dependent on the difference between the container temperature and a/the desired temperature.

42. The heating arrangement of claim 37, wherein the controller is configured to:
(a) determine whether the temperature of the heating element exceeds a predetermined maximum temperature, wherein the predetermined maximum temperature is preferably less than about 150 degrees C., more preferably between 100 and 150 degrees C., and if so to energise the cooling element and optionally deactive the heating element, and
(b) determine whether the temperature of the heating element has fallen below the predetermined maximum temperature by a predetermined amount, preferably up to about 5 degrees and more preferably 4 to 5 degrees, and if so to deactivate the cooling element and optionally energise the heating element, and preferably wherein the controller is configured to repeat the steps (a) and (b) until the container reaches a required temperature.

43. The heating arrangement of claim 37, wherein, in response to an indication that the appliance is in a predetermined state, preferably an inactive state, the controller is arranged to determine whether the temperature of the container and/or the heating element is above a predetermined threshold, preferably a safe threshold, optionally below about 40 degrees C., and if so, to activate the cooling element until the temperature falls below the threshold by a predetermined amount, preferably about 4 to 5 degrees or more, optionally to about 35 degrees C. or less.

44. The heating arrangement of claim 26, further comprising a container temperature sensor and a resilient element, wherein the resilient element urges the container temperature sensor against the container and preferably the heating element is configured to be urged against the container.

45. A heating arrangement for a cooking appliance including a container, the heating arrangement comprising:
a heating element; and
a resilient element configured to urge the heating element against the container;
preferably further comprising a container temperature sensor, wherein the resilient element is configured to urge both the container temperature sensor and the heating element against the container.

46. The heating arrangement of claim 44, wherein a/the controller is configured to permit activation of the heating element responsive to the resilient element being urged against the container.

47. The heating arrangement of claim 26, wherein the heating element has a maximum achievable temperature of less than approximately 150 degrees C., optionally less than approximately 100 degrees C., and more preferably equal to or less than approximately 70 degrees C., and/or wherein the controller is configured to heat and/or cool the container to a temperature between about 35 degrees C. and 75 degrees C.

48. A heating arrangement for a cooking appliance including a container, the heating arrangement optionally being according to claim 26, the heating arrangement comprising:
a heating element for heating the container, wherein the heating element has a power rating of less than or equal to 750W, and preferably less than or equal to 500W, and more preferably less than or equal to 300W, and/or wherein the heating element is configured to heat to a maximum temperature of 150 degrees C. or less, or 100 degrees C. or less, more preferably 70 degrees C. or less;
preferably further comprising a controller configured to energise the heating element, and preferably energise the heating element based on a temperature of the container.

49. The heating arrangement of claim 48, further comprising:
a container receiving member configured to releasably retain the container; and
a resilient urging means configured to urge the heating element into contact with the container when located in the container receiving member.

50. A cooking appliance, preferably a stand mixer, comprising:
the heating arrangement of claim 26; and
preferably a tool configured to agitate contents of the container.
